(19) United States
(12) Patent Application Publication
(10) Pub. No.: US 2010/0281493 A1
(43) Pub. Date: Nov. 4, 2010

(54) SLIM OPTICAL DISK DRIVE

(76) Inventors: Yao-Ching Tsai, Guishan Shiang (TW); Jen-Chen Wu, Guishan Shiang (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/701,840

(22) Filed: Feb. 8, 2010

(30) Foreign Application Priority Data
May 4, 2009 (TW) 098114882

(51) Int. Cl. G11B 17/04

(52) U.S. Cl. 720/601; G9B/17.013

(57) ABSTRACT

The invention is to provide a slim optical disk drive, which includes several braces extended from two edges of an upper cover. Each brace extends two fixing parts with a buckle hole from the center and the bottom. The upper and lower surface of each guide of a guide unit is concaved to form position recesses with a wedge. The guide places between two fixing parts, the fixing part and engages in the position recess, and the wedge is inserted into the buckle hole. A tray covered a base plate on bottom is supported by two bars sliding in two guides.

### FIELD OF THE INVENTION

The present invention is related to an optical disk drive for data storage, particularly to a slim optical disk drive with a tray used for supporting an optical disk to load and unload.

### BACKGROUND

With the consumption trend, a notebook is getting lighter, thinner and smaller. An optical disk drive, as one of the main part of the notebook, must correspondingly lightened weight and a further reduced thickness, so as to be assembled in a narrower space in the notebook and therefore facilitating the easy-carrying and storage of the notebook.

As shown in FIG. 1, a conventional optical disk drive 1 comprises a plastic tray 3, on which an optical disk 4 is supported, is contained in a hollow cover 2 in the conventional optical disk drive 1. Moreover, at both sides of the hollow cover 2, there is fixedly provided with a guide 5, inside which a bar 6 slides, in such a way one end of the bar 6 is allowed to stick out of or retract into the hollow cover 2, thus supporting the plastic tray 3 at two side thereof to slide into or out of the hollow cover 2. At the bottom of the plastic tray 3, a servo printed circuit board (PCB) 7 is provided for the control of the optical disk drive, and a metal base plate 8 is further provided under the servo PCB 7 for the isolation of electronic components on the plastic tray 3 from being touched and electric magnetic interference (EMI).

The hollow cover 2 of the conventional optical disk drive 1 is made of metal or the like, and could be separate into an upper cover and a bottom cover enclosing the optical disk drive cooperatively, in such a way that this optical disk drive is more bulky with an increased thickness H. In some prior arts, the cover 2 is hollowed out in an appropriate place to reduce the weight of the cover 2, but still incapability of lowering the thickness of the optical disk drive. Additionally, in the prior art of U.S. published Patent Application No. 2006/0005212, disclosed an optical disk drive without its upper cover and bottom cover, in which only a frame is used to enclose a back and guides both sides of a tray as well as support the tray to slide thereon, and in order to reduce weight together with thickness. During the manufacturing, assembly and testing of this exposed top side optical disk drive, there will be no protection against the fragmentation cause by the high-speed rotation optical disk. Furthermore the laser emitted from a pick-up head may be easily leaked. Due to the above situations this structure would cause some serious safety threats to the operators who involved in the manufacturing. Because of explosion, a precise and precious optical pick-up lens is also more likely to be touched and even damaged. Although the bottom of the optical disk drive is protected by the base plate, EMI isolation at the top side thereof may not be obtained effectively by the use of plastic tray only, but may be provided by the cooperation of an isolation device of the notebook instead, leading to a restriction on the location of the optical disk drive, and thus the increased difficulty in design.

Therefore, U.S. published Patent Application No. 2006/0285288 was further proposed to disclose an optical disk drive with a metal protecting plate apply on the upper cover after the optical disk drive is assemble in the notebook. The metal protecting plate is used for EMI isolation and protection. The additional metal protecting plate is equivalent to the upper cover of the optical disk drive, however, and thus the effect of reducing the weight and the thickness of the optical disk drive is completely lost. Moreover, the problems of fragments protection, laser leak and the exposed optical lens during manufacturing are never solved by the metal protecting plate. Thus, there are still problems in thinning and lightening the conventional optical disk drive to be solved necessarily.

### SUMMARY OF THE INVENTION

It is an object of the present invention to provide a slim optical disk drive having braces extending from an upper cover to fix guides with preserved overall safety of the optical disk drive so as to reduce weight by removing the bottom cover.

It is another object of the present invention to provide a slim optical disk drive having braces inserted into concaved positioning recesses of guides, in such a way that the thickness of each brace may be eliminated to facilitate the thickness reduction of the optical disk drive.

It is a further object of the present invention to provide a slim optical disk, in which a buckle hook at the bottom of each of braces is inserted into a hooking recess at the side of each of guides, respectively, so as to eliminate the thickness of the brace, facilitating the thickness reduction of the optical disk drive.

To achieve above-mentioned objects of the present invention, a slim optical disk drive of the present invention comprises a plurality of braces extending downward from the edges of an upper cover. Each of the braces extending provided a fixing part with a buckle hole from the middle and the bottom, respectively. Each of the guides in a guide unit is formed with a concaved positioning recess at the top and bottom thereof, respectively. Additionally, each of the braces provides with a wedge. The guides being enveloped between the two fixing parts and the fixing parts being assembled in the positioning recess, the wedge tenoned into the buckle hole. Each of the bars in a bar unit is used to cooperate with the guides and support by a tray to slide at two sides thereof, the bottom of the tray covering over a base plate.

A slim optical disk drive of another embodiment of the present invention comprises a plurality of braces extending downward from each of two edges of an upper cover, each of the braces being extended from the middle thereof with a fixing part having a buckle hole, and being formed at the bottom thereof as a buckle hook. Each of the guides in a guide unit is formed at the top thereof with concaved positioning recesses, in each of which there is provided with a wedge. The outer surface of the each of the guides formed a hooking recess, respectively. The guides assembled on the braces and the fixing part will be tenoned in the positioning recess. The wedge inserted into the buckle hole and the buckle hook tenoned into the hooking recess. Each of the bars in a bar unit is put inside the guide correspondingly, and support by a tray to slide at two sides thereof, the bottom of the tray is cover over a base plate.

### BRIEF DESCRIPTION OF DRAWINGS

FIG. 1 is a partial cross-sectional view of a conventional slim optical disk drive.

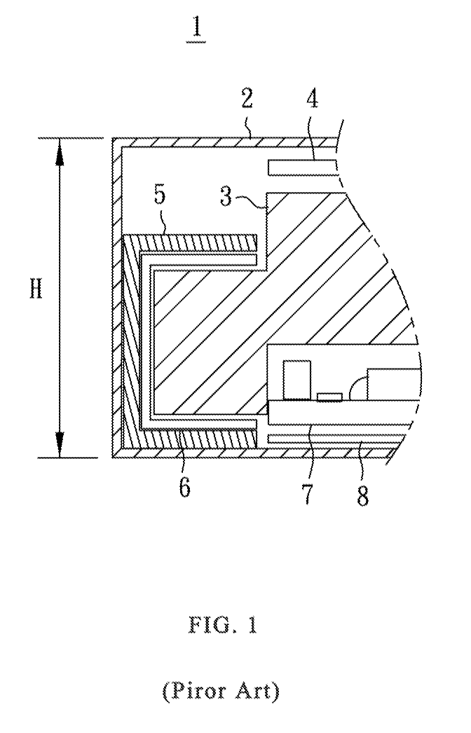

FIG. 2 is a front view of the disassembled structure of a slim optical disk drive of the present invention.

FIG. 3 is a rear view of the disassembled structure of the slim optical disk drive of the present invention.

FIG. 4 is a front assembly view of the assembled slim optical disk drive of the present invention.

FIG. 5 is a rear assembly view of the assembled slim optical disk drive of the present invention.

FIG. 6 is a cross-sectional view taken along the line A-A of FIG. 4.

FIG. 7 is a partial cross-sectional view of a slim optical disk drive of another embodiment of the present invention.

### DETAILED DESCRIPTION

Technical measures taken for achieving above-mentioned objects of the present invention and effects thereof will be described taken in conjunction with figures.

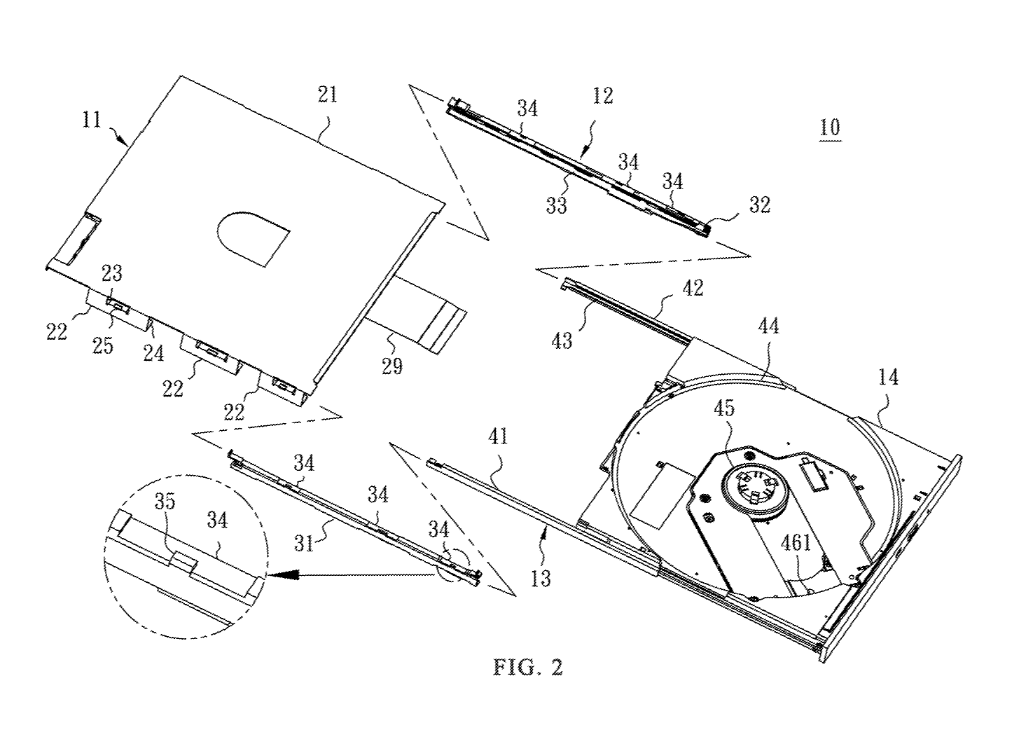

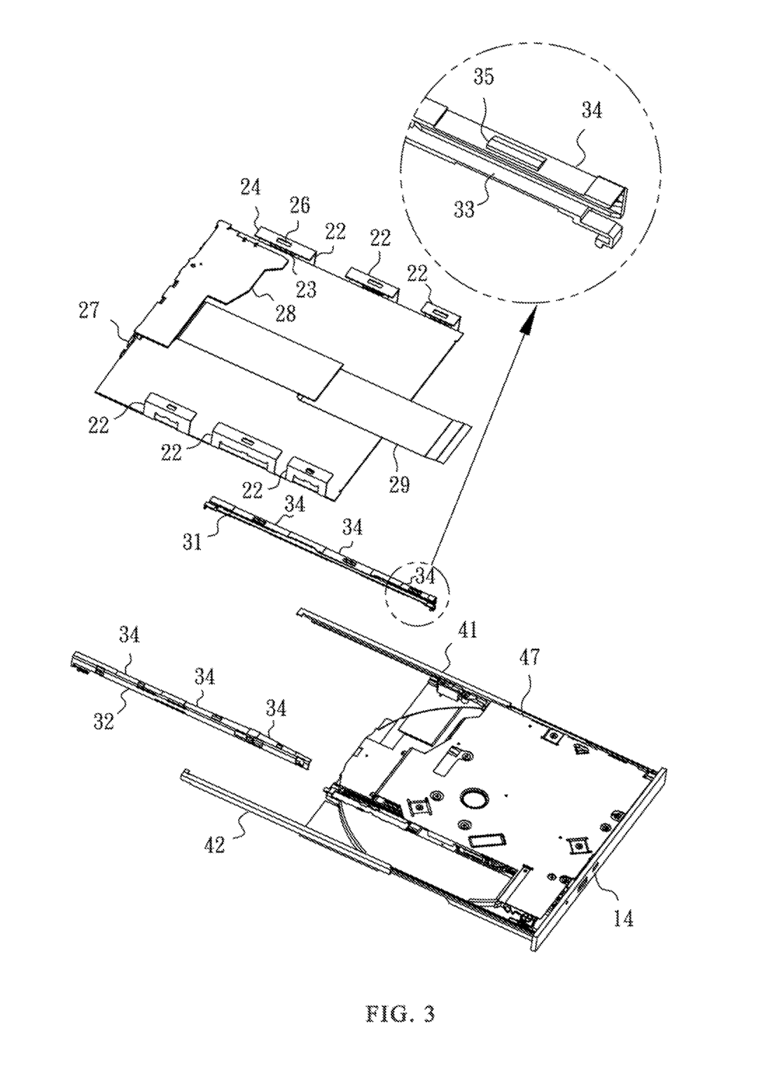

Referring to FIG. 2 together with FIG. 3, FIG. 2 shows a front view of the disassembled structure of a slim optical disk drive 10 of the present invention, and FIG. 3 shows a rear view of the disassembled structure thereof. The slim optical disk drive 10 of the present invention mainly comprises an upper cover 11, a guide unit 12, a bar unit 13, and a tray 14. The upper cover 11 includes a main body 21 generally in the form of a flat plate. At each of the two edges of the main body 21, there are provided, respectively, with a plurality of braces 22 extending downward. In this embodiment, three braces 22 provided at each side are taken as an example. Each brace 22 is formed in an inverted-F shape, and further extended a first fixing part 23 and a second fixing part 24 form the middle and the bottom of the brace, respectively. Each braces extending inward into the optical disk drive 10 and partly parallel with the main body 21. The first fixing part 23 is provided thereon with a first buckle hole 25, and the second fixing part 24 is provided thereon with a second buckle hole 26. The upper cover 11 is additionally provided with at least one fixing plate 27, which, extending downward along the back edge of the main body 21, is used for fixing a main board 28 of the optical disk drive 10, in such a way that the main board 28 may be laid in parallel to the main body 21, and at a certain distance below the body 21. One end of a flexible wire harness 29 is connected with one end of the main board 28, while the other end of the flexible wire harness 29 is extended to the front side of the main body 21.

The guide unit 12 includes a left guide 31 and a right guide 32. The left guide 31 and the right guide 32 are a three-sided enclosing wall structure, in which could be work as a sliding recess 33. The height of each of these guides is approximately equivalent to the distance between the first fixing part 23 and the second fixing part 24. For each of the guides 31, 32, it may be made of plastic for the reduction of friction and noise, and provided with a thicker enclosing wall for the enhancement of structural strength. At the top and bottom of the guide 31, 32, where thicker enclosing walls are used, could further conjunct a consideration number of the braces 22, and so as positioning recesses 34 is provided. Each positioning recess 34 may cooperate with the enclosing walls at the top and bottom of each of the guides 31, 32. The height of each positioning recess 34 may be approximately larger than the thickness of the upper cover 11. In each positioning recess 34, there is further projectingly provided with a wedge 35, the height of which is approximately equivalent to the thickness of the upper cover 11, and the size of which is approximately smaller than that of the corresponding first buckle hole 25 or second buckle hole 26, allowing this wedge to be inserted into the first buckle hole 25 or second buckle hole 26.

The bar unit 13 further comprises a left bar 41 and a right bar 42, each of the bars is formed with a sliding groove 43, which, composed of three-sided enclosing wall, opens toward the inside of the optical disk drive 10. The heights of the left bar 41 and the right bar 42 are adapted such that these bars may be just accommodated, and then moved inside the sliding recesses 33 of the left guide 31 and the right guide 32, respectively. On the top surface of the tray 14, there is provided with a disk recess 44, in which a spindle motor 45 and a pick-up head 46 used for supporting and rotating the optical disk are provided. On the bottom of the tray 14, there are provided a servo printed circuit board and electronic components (not shown), covered by a metal base plate 47 for EMI isolation, for the control of the spindle motor 45 and the pick-up head 46.

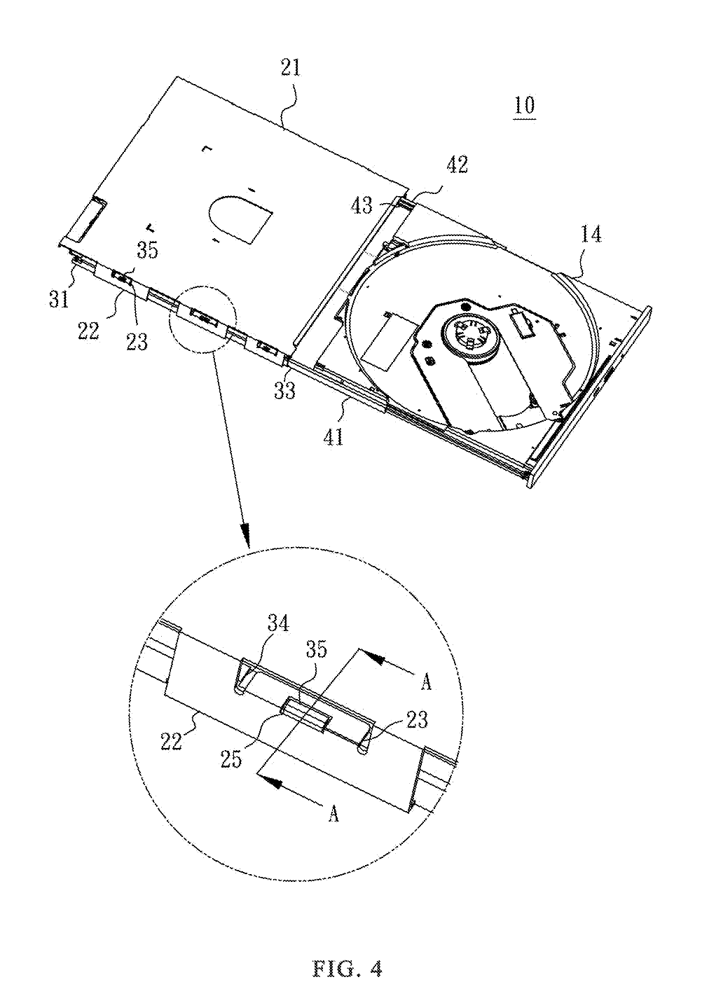

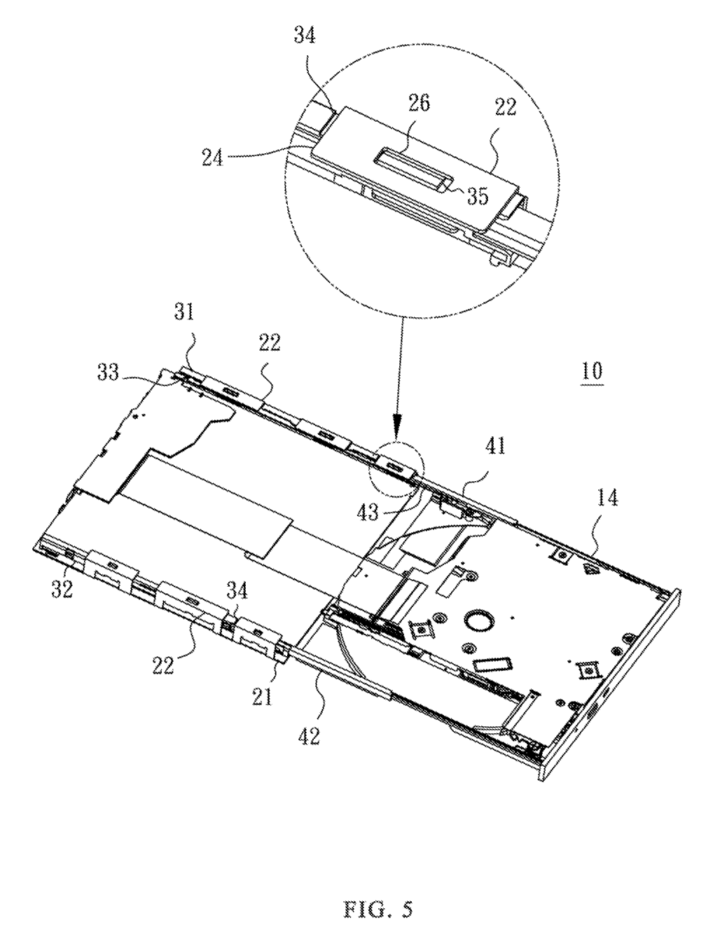

Referring to FIG. 4 together with FIG. 5, there are shown front and rear views of an assembled slim optical disk drive 10 of the present invention, respectively. For the slim optical disk drive 10 of the present invention, the left guide 31 and the right guide 32 may be received between the first fixing part 23 and the second fixing part 24 of the brace 22, respectively. The first fixing part 23 and the second fixing part 24 laid at each edge of the main body 21, while the sliding recess 33 opens toward the inside of the optical disk drive 10. The first fixing part 23 of each brace 22 is allowed to enter into the positioning recesses 34 on the left guide 31 and the right guide 32 correspondingly one after another, and then the wedge 35 of each positioning recess 34 is allowed to insert into the first buckle hole 25 of each first fixing part 23 one by one, causing the brace 22 to be caught into the positioning recess 34 without projecting out of this positioning recess 34. On the other hand, the second fixing part 24 is assembled into the positioning recesses 34 at the bottom of the left guide 31 and the right guide 32 correspondingly one after another, and then the wedge 35 of each positioning recess 34 is allowed to insert into the second buckle hole 26 of each second fixing part 24 one by one, causing the brace 22 to be caught into the positioning recess 34 without projecting out of this positioning recess 34. The left guide 31 and the right guide 32 are thus fixed at the both sides of the upper cover 11. Subsequently, the left bar 41 and the right bar 42 are inserted into the sliding recesses 33 of the left guide 31 and the right guide 32, respectively, in which the sliding grooves 43 of the left bar 41 and the right bar 42 face toward the inside of the optical disk drive 10. Both sides of the tray 14 are extended into the sliding groove 43 of the left bar 41 and the right bar 42, and then slidingly moved therein. The tray 14 is supported at both sides thereof by the left bar 41 and the right bar 42, allowing it to slide into and out of the upper cover 11.

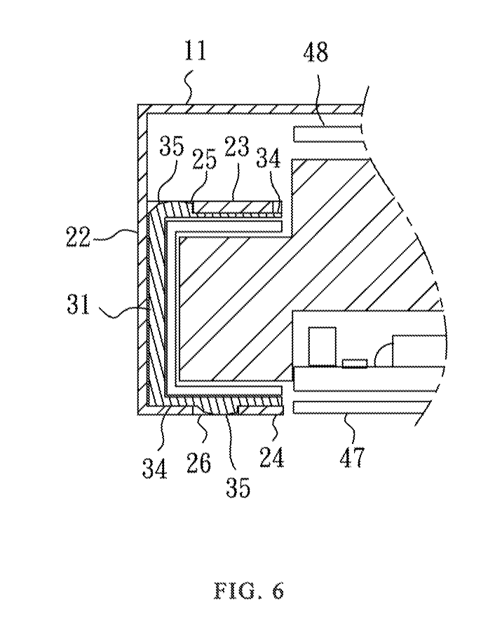

In FIG. 6, there is shown a cross-sectional view taken along the line A-A of FIG. 4. For the present invention the upper cover 11 includes an inverted-F brace 22. Further the inverted-F brace 22 extends the first fixing part 23 and the second fixing part 24, which may coincide with the positioning recesses 34 exactly. The wedges 35 on the positioning recesses 34 may insert into the first buckle hole 25 and the second buckle hole 26 of these first and second fixing parts exactly. Due to the aforesaid structure, this structure could fix the guide 31 securely and achieve the object of weight reduction by removing the bottom cover. Furthermore, the overall thickness of the optical disk drive may be reduced due to the fact that the second fixing part 24 may not project out of the surface of the guide 31 any more. Meanwhile, the protection against the fragments of an optical disk 48 may be obtained, and the exposure of the laser from the pick-up head may be prevented, owing to the preservation of the upper cover 11 to cover the top side of the optical disk drive in the present invention. Additionally, EMI may be also prevented by the cooperation with the base plate 47 covering the bottom of the optical disk drive.

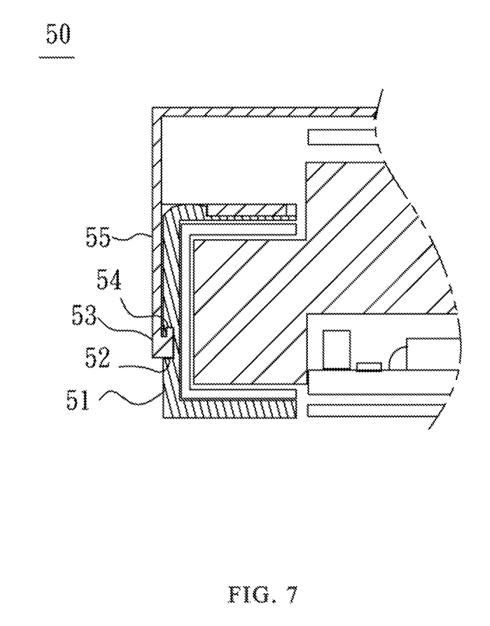

In FIG. 7, there is shown a slim optical disk drive 50 of another embodiment of the present invention. This embodiment and the prior one are similar in basic configuration, while the difference there between is that, instead of the connection between the bottom faces of the left and right guides and the second fixing parts in the prior embodiment, an outer face 51 of each of the left and right guides, in the present invention, is formed with a plurality of hooking recesses 52 with which the second fixing parts 53 of the braces 55 formed as buckle hooks 54 are connected. Thus, the overall thickness of the optical disk drive may be equally lowered.

Therefore, the object of reducing weight by removing the bottom cover is achieved by the slim optical disk drive of the present invention, in which the braces extend from the upper cover to fix the guides with preserved overall safety of the optical disk drive. Moreover, either the insertion of the braces into the concaved positioning recesses of the guides, or the buckling provided at the outer faces of the guides may be also used, in such a way that the thickness of each brace may be eliminated to facilitate the thickness reduction of the optical disk drive.

The foregoing description is only embodiments for illustrating the present invention, but the scope of the present invention is not limited thereto. All variations made in accordance with the present invention without departing from the spirit of the invention are intended to be embraced in the appended claims.

1. A slim optical disk drive, comprising:
an upper cover, said upper cover integrally provided a plurality of braces extending downward from two edges of said upper cover, from the middle and the bottom of each said braces respectively provided a fixing part extending inward into said optical disk drive and said fixing part is partly parallel to said upper cover, said fixing part being provided thereon with a buckle hole;
a guide unit, comprising a left guide and a right guide, at the top and bottom of each said guides respectively provided a concaved positioning recesses located at corresponding positions with respect to said braces, each of said positioning recesses being projectingly provided therein with a wedge, said left guide and said right guide being provided between said two fixing parts of each of said braces extending from said two edges of said upper cover, respectively, said fixing parts entering into said positioning recesses correspondingly, said wedge being inserted into said buckle hole;
a bar unit, comprising a left bar and a right bar put inside said left guide and said right guide, respectively; and
a tray, the bottom of which covers over a base plate, supported to slide at two sides thereof by said left bar and right bar.

2. The slim optical disk drive according to claim 1, wherein said upper cover is provided three braces at each of two edges extending downward.

3. The slim optical disk drive according to claim 1, wherein the concaved depth of each of said positioning recesses is greater than the thickness of said upper cover.

4. The slim optical disk drive according to claim 1, wherein said upper cover is integrally provided at the back edge thereof with at least one fixing plate, extending downward, used for fixing a main board.

5. A slim optical disk drive, comprising:
an upper cover, integrally provided a plurality of braces extending downward from each of two edges, from the middle of said brace provided with a fixing part extending inward into said optical disk drive and in partly parallel to said upper cover, said fixing part being provided thereon with a buckle hole, each of said braces being formed at the bottom thereof as a buckle hook;
a guide unit, comprising a left guide and a right guide, on the top of each said guides provided a concaved positioning recesses located at corresponding positions with respect to said braces, each of said positioning recesses being projectingly provided therein with a wedge, each of said guides being formed at the outer surface thereof with a hooking recess, said left guide and said right guide being provided on each of said braces extending from said two edges of said upper cover, respectively, said fixing parts entering into said positioning recesses correspondingly, said wedge being inserted into said buckle hole, said buckle hook being connected to said hooking recess;
a bar unit, comprising a left bar and a right bar assembled with said left guide and said right guide, respectively; and
a tray, the bottom of which covers over a base plate, supported to slide at two sides thereof by said left bar and right bar.

6. The slim optical disk drive according to claim 5, wherein said upper cover provided three braces at each of two edges extending downward.

7. The slim optical disk drive according to claim 6, wherein said upper cover is integrally provided at least one fixing plate at the back edge, extending downward, used for fixing a main board.
